(19) United States
(12) Patent Application Publication
(10) Pub. No.: US 2011/0102454 A1
(43) Pub. Date: May 5, 2011

(54) IMAGE PROCESSING DEVICE, IMAGE PROCESSING METHOD, IMAGE PROCESSING PROGRAM, AND IMAGING DEVICE

(75) Inventors: Ryuichi MIYAKOSHI, Osaka (JP); Yasunobu Ogura, Osaka (JP)

(73) Assignee: Panasonic Corporation, Osaka (JP)

(21) Appl. No.: 12/985,665

(22) Filed: Jan. 6, 2011

Related U.S. Application Data
(63) Continuation of application No. PCT/JP2009/003441, filed on Jul. 22, 2009.

(30) Foreign Application Priority Data
Sep. 8, 2008 (JP) 2008-229858

(51) Int. Cl. G09G 5/02

(52) U.S. Cl. 345/589

(57) ABSTRACT

The detection result and brightness information of a specific region are stored, and once latest image data is input, the degree of importance is calculated based on the stored detection result and brightness information and the detection result and brightness information of the specific region in the latest image. Based on the degree of importance, whether to display specific region information is determined. The brightness information is calculated based on the detection result of the specific region.

### CROSS-REFERENCE TO RELATED APPLICATION

This is a continuation of PCT International Application PCT/JP2009/003441 filed on Jul. 22, 2009, which claims priority to Japanese Patent Application No. 2008-229858 filed on Sep. 8, 2008. The disclosures of these applications including the specifications, the drawings, and the claims are hereby incorporated by reference in their entirety.

### BACKGROUND

The present disclosure relates to an image processing technology for displaying the detection result of a specific region (e.g., a face region) with high precision.

In recent years, it has been becoming popular for imaging devices, such as digital cameras (digital still cameras, digital video cameras, camera-equipped cellular phones, etc.), monitor cameras, and door phone cameras, as well as image processing devices, to be equipped with a face region detection function. In digital still cameras, a detected face region is subjected to automatic focus (AF) control and automatic exposure (AE) control. In monitor cameras, a detected face region is stored for use to identify a suspicious person.

Many techniques have been invented for detection of a face region, including a method of detection from the positional relationship among parts (the eyes, the mouth, etc.) of a standard face, a method of detection based on the color and edge information of a face, and a method of detection from comparison with face characteristic data prepared in advance. In any of the above methods, the detection result is affected by minute changes in the position, brightness, and angle of view of the face region to be detected. Assuming the detection performed for continuous frames, the detection result will vary from one frame to another even if the subject to be detected is at rest. If face frame information is prepared based on the detection result and displayed on a “through image” (monitored image with no internally generated symbols or characters overlapped) using the on-screen display (OSD) function, etc., the position and size of the face frame will change constantly, making the image very hard to see.

Japanese Patent Publication No. 2008-54295 (Patent Document 1) describes an imaging device having a configuration schematically shown in FIG. 2. In this device, a face detection section 206 detects a face region from an image taken, and stores a detection history including past and latest detection results of the face region in an internal memory 207. A determination section 208 determines whether to regard the face region as detected in the latest acquired image by referring to the detection history. When regarded as detected, the face region is smoothed with reference to the detection history again, and displayed on a through image. In this way, the problem that the image is very hard to see due to changes in the position and size of the face frame is overcome.

### SUMMARY

In digital still cameras and monitor cameras equipped with the face region detection function, a face region is detected for continuous frames and the detection result is displayed on a through image in not a few cases. In Patent Document 1 above, a technique is proposed where M past and latest face detection results are stored in the inner memory 207 as a detection history, and, by referring to the detection history, any detection result having been linked N (M≧N) or more times is smoothed, and the smoothed result is displayed on a through image, to thereby overcome the problem that the image is very hard to see due to changes in the position and size of the face frame. The detection result at each time includes the number of faces detected and information on each face comprised of unique information and link information. The unique information refers to information including the center position, size, tilt, and orientation of a face, and the face likelihood value indicating the likelihood of the face detected, output from the face detection section 206. The link information refers to information on association of past and latest detection results with each other prepared based on the unique information. However, when detection results as shown in FIGS. 3A-3C are obtained continuously, for example, link information will not be updated correctly, resulting in defective display of the face frame. FIGS. 3A-3C show a case where subject (A) 302, 305, 308 and subject (B) 303, 306, 309 different in brightness value are taken in continuous three frames. FIG. 3A shows two-frame preceding frame data, and FIG. 3B shows one-frame preceding frame data. FIG. 3C shows the latest frame data, where the one-frame preceding subject (A) 305 and subject (B) 306 shown in FIG. 3B have moved to the positions of the subject (A) 308 and the subject (B) 309. Assume that M=3 and N=2 in Patent Document 1 and the two-frame preceding subject (A) 302 and the one-frame preceding subject (A) 305, and the two-frame preceding subject (B) 303 and the one-frame preceding subject (A) 306, have been respectively linked together. In this case, in updating the link information with the detection result of the latest frame, the subject (A) 308 will be linked to the detection results of the subject (B) 303 and 306. If the determination section 208 determines whether to regard the face regions as detected in the latest frame 307 by referring to the detection history in FIGS. 3A-3C and displays face frames based on the determination result, face frames 310 and 311 shown in FIG. 3C will be displayed; the face frame 310 is for the subject (A) and the face frame 311 for the subject (B). This wrong linking will lead to failure in correct face frame display. Also, assuming a camera system that sets an AF target based on the face detection result, if the subject (B) 303 and 306 has been set as an AF target in FIGS. 3A and 3B, the setting of the AF target will change by this wrong linking.

It is an objective of the present invention to display specific region information (e.g., a face frame) obtained based on the detection result of a specific region (e.g., a face region) on a through image correctly in an easy to see manner.

To attain the above objective, in an embodiment of the present invention, the detection result and brightness information of a specific region (e.g., a face region) in input image data are stored, and once latest image data is input, the degree of importance is calculated based on the stored detection result and brightness information and the detection result and brightness information of the specific region in the latest image. Based on the degree of importance, whether to display specific region information is determined. In an embodiment, the brightness information is calculated based on the detection result of the specific region.

According to the present invention, specific region information (e.g., a face frame) obtained based on the detection result of a specific region (e.g., a face region) can be displayed on a through image correctly in an easy to see manner.

### BRIEF DESCRIPTION OF THE DRAWINGS

FIG. 1 is a block diagram showing the entire configuration of an imaging device of the first embodiment of the present invention.

FIG. 2 is a block diagram showing a schematic configuration of a device in Patent Document 1.

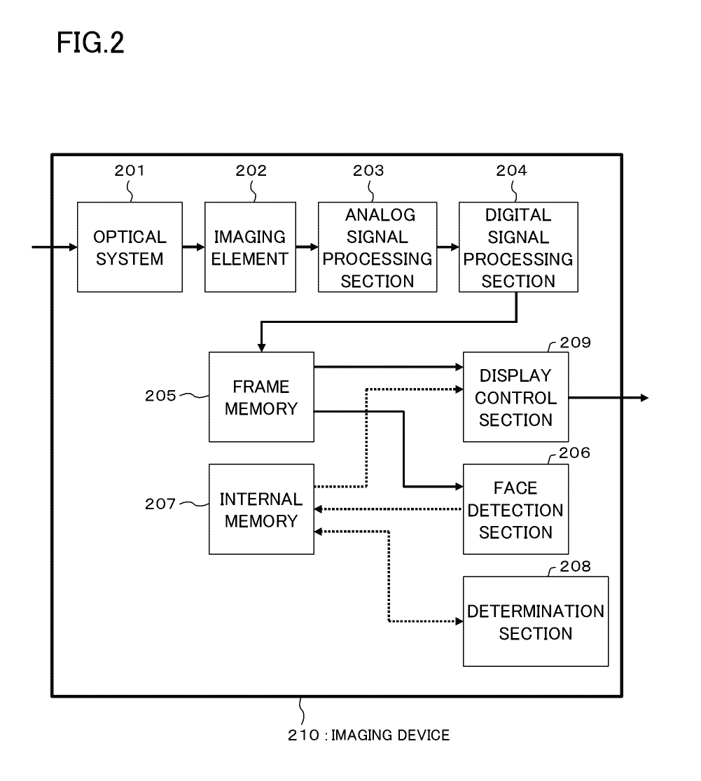

FIGS. 3A-3C are views illustrating a conventional problem.

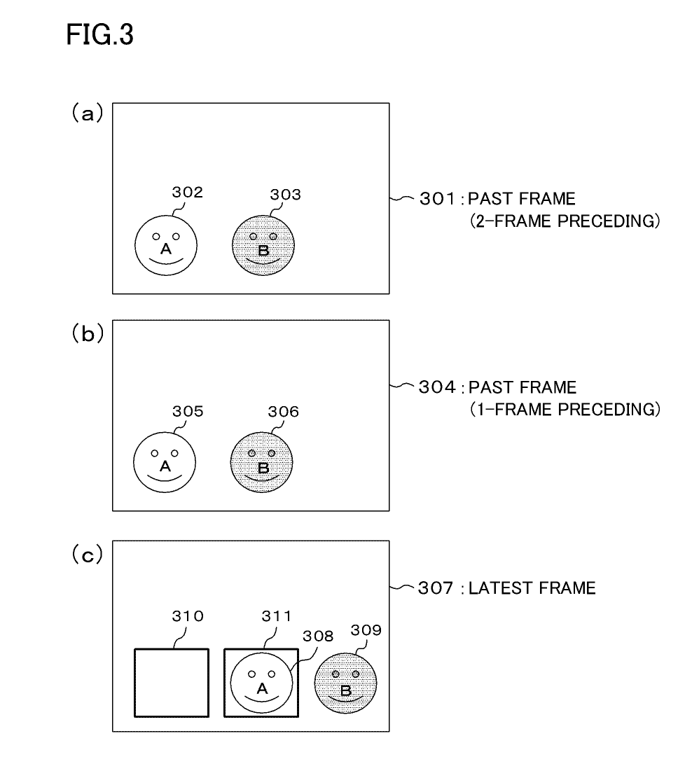

FIG. 4 is a flowchart showing a flow of processing performed by an image processing device 113 shown in FIG. 1.

FIG. 5A is a view showing a configuration of data output from a face detection section 106, and FIG. 5B is a view showing a configuration of data stored in an information storage section 109.

FIG. 6 is a flowchart showing a flow of dividing image data into F×G blocks and calculating brightness information based on the detection result for the latest image data.

FIG. 7 is a flowchart showing a flow of dividing image data into blocks based on the detection result for the latest image data and calculating brightness information based on the detection result for the latest image data.

FIG. 8 is a flowchart showing a flow of initialization of the information storage section 109.

FIG. 9 is a flowchart showing a flow of calculation of the degree of importance by an importance degree calculation section 108.

FIG. 10 is a flowchart showing a flow of deletion of face information by an information deletion determination section 111.

FIG. 11 is a flowchart showing a flow of determination of display by a display determination section 110 and display of a face frame by a display control section 112.

FIGS. 12A-12B are views illustrating a problem of the first embodiment.

FIG. 13 is a flowchart showing a flow of update of face information by the second embodiment.

### DETAILED DESCRIPTION

Embodiments of the present invention will be described hereinafter with reference to the drawings. Note that the embodiments to follow are merely illustrative and can be modified in various ways. Note also that, in the embodiments to follow, a face detection section for detecting a face region of a person will be taken and discussed as a concrete example of a specific region detection section that is a component of the present invention. In relation to this, face information will be discussed as an example of specific region information.

### First Embodiment

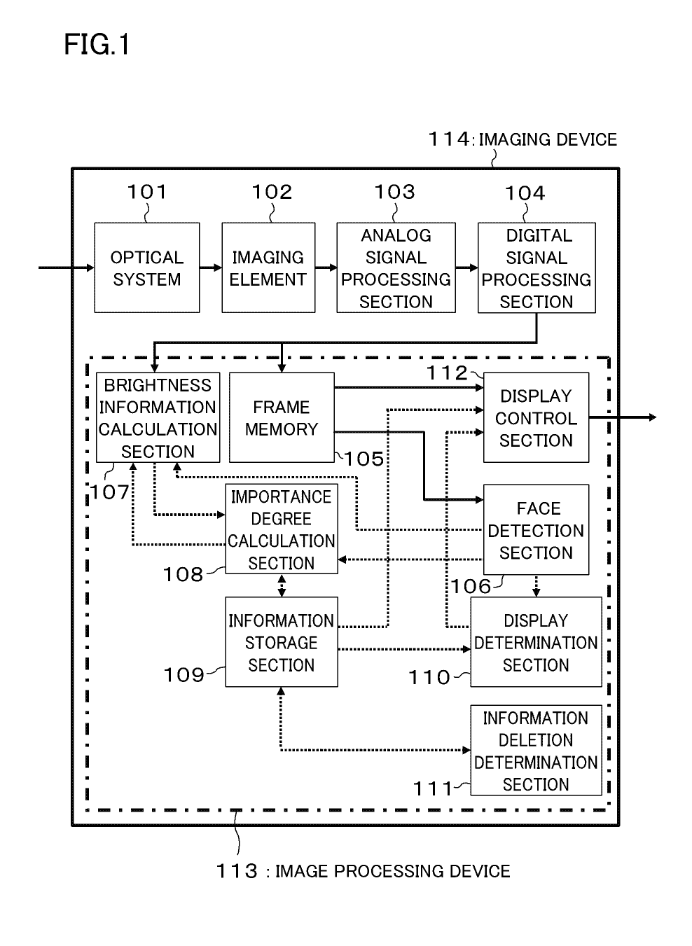

FIG. 1 is a view showing the entire configuration of an imaging device of the first embodiment of the present invention. The imaging device 114 includes an optical lens (optical system) 101, an imaging element 102, an analog signal processing section 103, a digital signal processing section, and an image processing device 113.

The optical lens 101 focuses a subject image on the imaging element 102. The imaging element 102 captures the subject image focused by the optical lens 101 (hereinafter, a CCD will be described as an example of the imaging element 102). The analog signal processing section 103 performs predetermined processing for an analog imaging signal output from the imaging element 102, to convert the signal to a digital imaging signal. The digital signal processing section 104 performs predetermined processing for the digital imaging signal output from the analog signal processing section 103. The image processing device 113 performs predetermined processing for the processed digital imaging signal (image data) output from the digital signal processing section 104 and displays a face frame on the image data.

The image processing device 113 includes a frame memory 105, a face detection section 106, a brightness information calculation section 107, an importance degree calculation section 108, an information storage section 109, a display determination section 110, an information deletion determination section 111, and a display control section 112.

The frame memory 105 stores the image data subjected to the digital signal processing. The face detection section 106 detects a face region of a person in the image data. The brightness information calculation section 107 calculates brightness information of a given region in the image data. The importance degree calculation section 108 calculates the degree of importance of the detection result output from the face detection section 106. The information storage section 109 stores face information including the detection result output from the face detection section 106, the brightness information output from the brightness information calculation section 107, and the degree of importance calculated by the importance degree calculation section 108, as well as the number of units of face information. The display determination section 110 determines whether to display the face information stored in the information storage section 109 based on the degree of importance. The information deletion determination section 111 determines whether to delete face information stored in the information storage section 109 based on the degree of importance. The display control section 112 displays a face frame on the image data according to the determination by the display determination section 110.

The degree of importance calculated by the importance degree calculation section 108 is a three-dimensional evaluation value calculated based on detection results for a plurality of units of image data, which is different from the likelihood of a detection result for one unit of image data output from the face detection section 106.

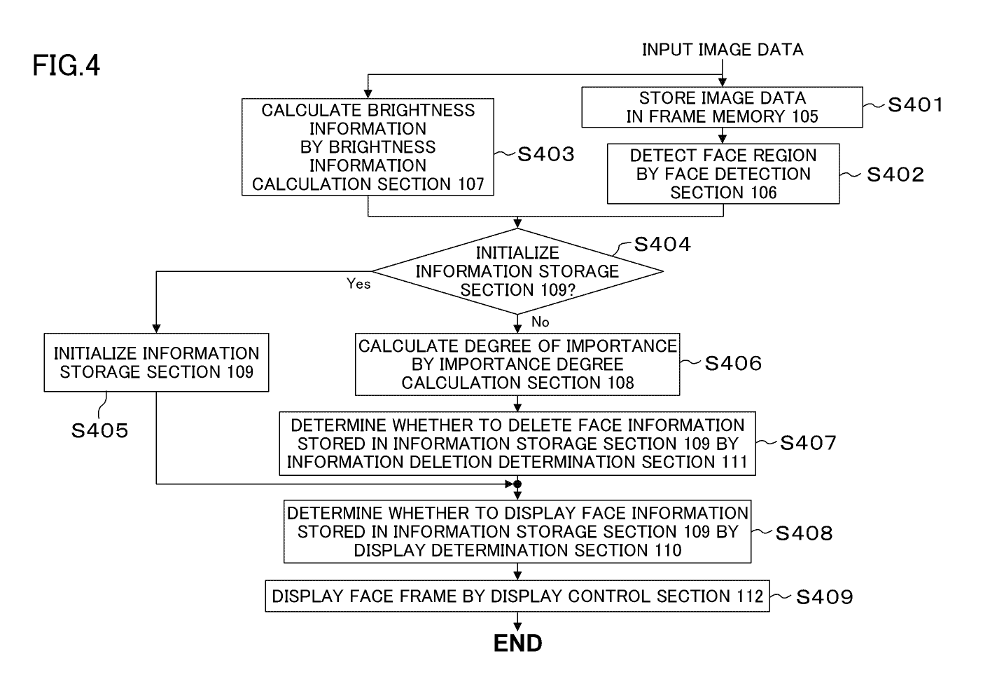

Next, the operation of the imaging device 114 configured as described above will be described. Description will be made hereinafter on the calculation of the degree of importance based on detection results and brightness information and the display based on the degree of importance, which constitute distinctive processing of the present invention. This processing, performed by the image processing device 113 in FIG. 1, will be described with reference to the flowchart of FIG. 4.

First, image data input into the image processing device 113 from the digital signal processing section 104 is stored in the frame memory 105 (S401), and the face detection section 106 detects a face region in the image data (S402). Also, the brightness information calculation section 107 calculates brightness information for the image data input into the image processing device 113 from the digital signal processing section 104 (S403).

Thereafter, whether to initialize the information storage section 109 is determined (S404). If the information storage section 109 is to be initialized (Yes at S404), any face information and the number of units of face information stored in the information storage section 109 are initialized (S405), and the process proceeds to step S408. If the information storage section 109 is not to be initialized (No at S404), the importance degree calculation section 108 calculates the degree of importance based on face information stored in the information storage section 109, the detection result output from the face detection section 106 for the latest image data, and the brightness information output from the brightness information calculation section 107 for the latest image data (S406). Based on the calculated degree of importance, the information deletion determination section 111 determines whether to delete face information stored in the information storage section 109 (S407).

Thereafter, the display determination section 110 determines whether to display the face information stored in the information storage section 109 based on the degree of importance (S408). According to the determination by the display determination section 110, the display control section 112 displays a face frame (S409)

Details of steps S403 through S409 of the above processing will be described hereinafter. As for steps S401 and S402, description is omitted because various known techniques are available.

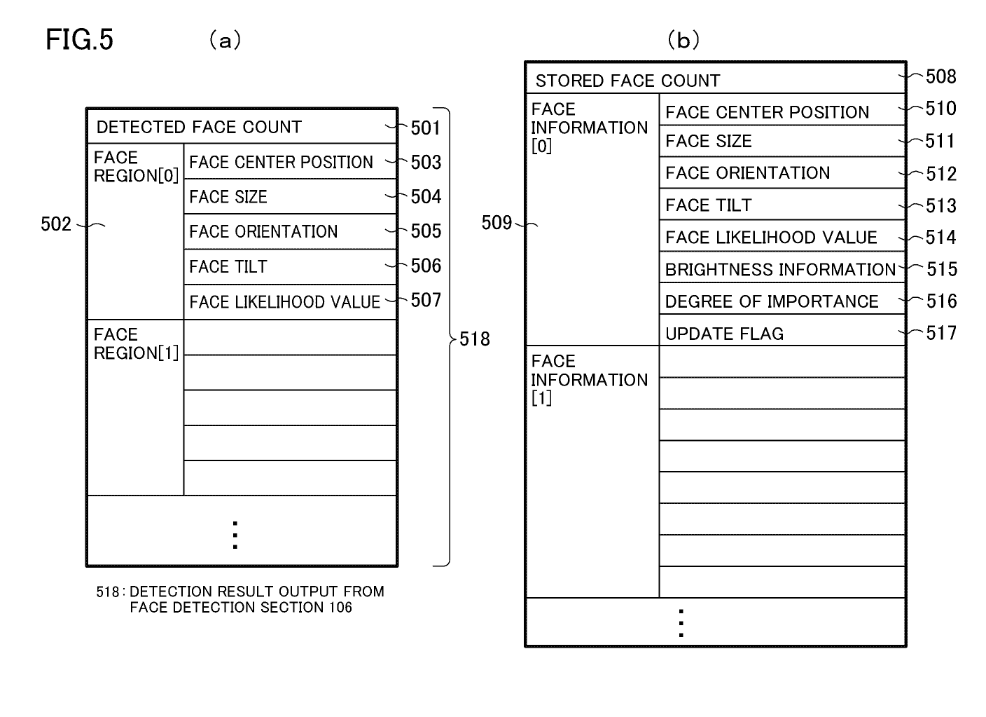

FIG. 5A shows face regions, as well as the number of face regions (detected face count), output from the face detection section 106, and FIG. 5B shows face information, as well as the number of units of face information (stored face count), stored in the information storage section 109.

As shown in FIG. 5A, a detection result 518 output from the face detection section 106 includes a detected face count 501 and face regions 502 of the number corresponding to the detected face count 501. Each face region 502 includes a face center position 503, a face size 504, a face orientation 505, a face tilt 506, and a face likelihood value 507. The face center position 503 may otherwise be represented by the positions of the four corners of the face region or by the x and y coordinates on the image data. The face orientation 505 and the face tilt 506 may be combined to be expressed as the face orientation.

As shown in FIG. 5B, the information storage section 109 stores a stored face count 508 and units of face information 509 of the number corresponding to the stored face count 508. Each unit of face information 509 includes a face center position 510, a face size 511, a face orientation 512, a face tilt 513, a face likelihood value 514, brightness information 515 calculated by the brightness information calculation section 107, a degree of importance 516 calculated by the importance degree calculation section 108, and an update flag 517 representing whether the degree of importance has been updated. Like the detection result 518 output from the face detection section 106, the face center position 510 may otherwise be represented by the positions of the four corners of the face region or by the x and y coordinates on the image data. The face orientation 512 and the face tilt 513 may be combined to be expressed as the face orientation.

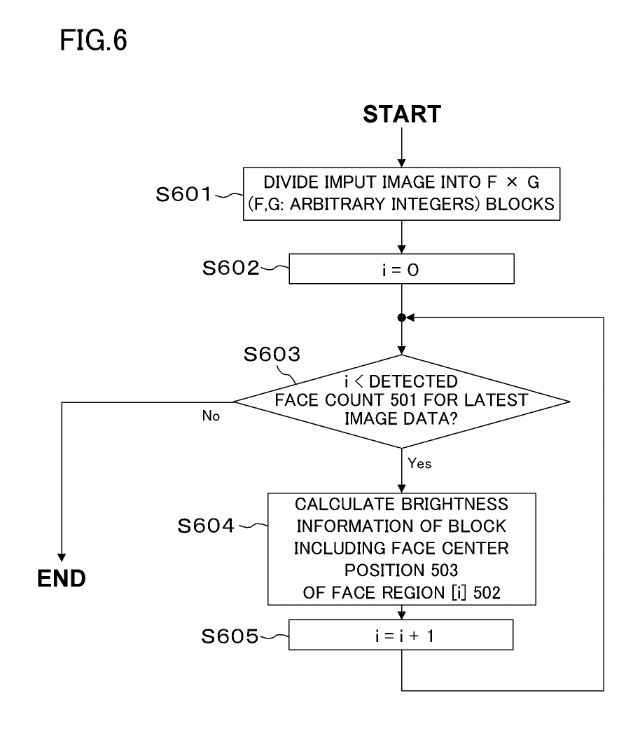

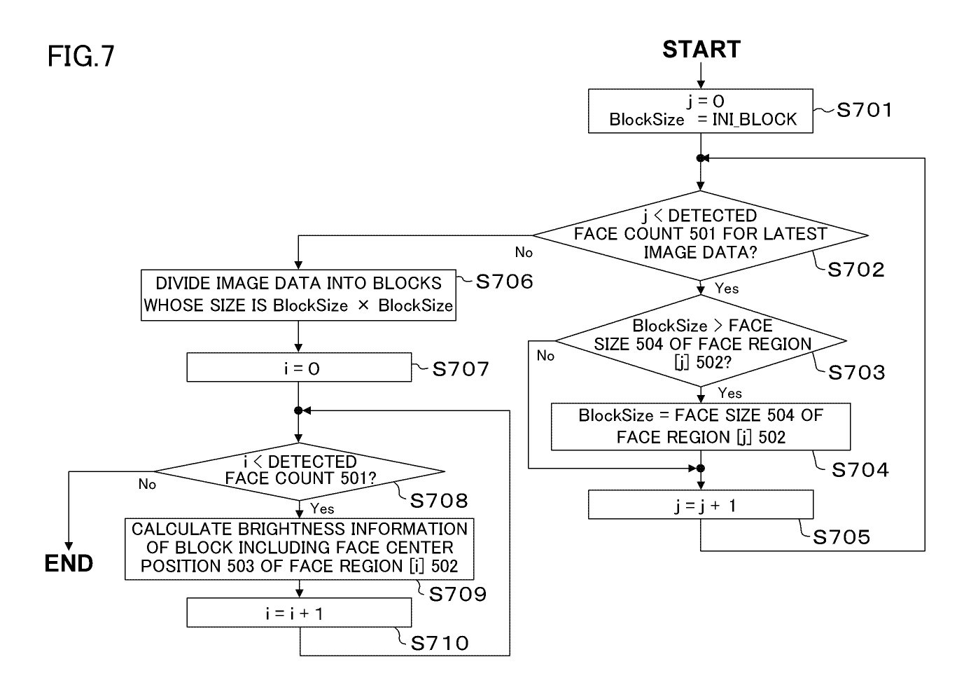

Details of the processing in step S403 will be described with reference to FIGS. 6 and 7.

FIG. 6 shows a flow of dividing the image data into F×G (F and G are arbitrary integers) blocks and calculating brightness information based on the detection result for the latest image data.

First, the input image data is divided into F×G blocks (S601), and a variable i for counting is initialized (S602). Thereafter, whether the variable i is smaller than the detected face count 501 for the latest image data is determined (S603). If the variable i is equal to or larger than the detected face count 501 (No at S603), the calculation of brightness information by the brightness information calculation section 107 is terminated. If the variable i is smaller than the detected face count 501 (Yes at S603), brightness information of a block including the face center position 503 of the face region [i] 502 is calculated (S604). The variable i is then incremented (S605), and the process returns to step S603.

By executing the processing in steps S601 through S605 as described above, brightness information is calculated.

FIG. 7 shows a flow of dividing the image data into blocks based on the detection result for the latest image data and calculating brightness information based on the detection result for the latest image data.

First, a variable j for counting and a variable BlockSize for block size setting are initialized (S701), and whether the variable j is smaller than the detected face count 501 for the latest image data is determined (S702).

If the variable j is smaller than the detected face count 501 (Yes at S702), whether the variable BlockSize is larger than the face size 504 of the face region [j] 502 is determined (S703). If the variable BlockSize is larger than the face size 504 of the face region [j] 502 (Yes at S703), the face size 504 of the face region [j] 502 is assigned to the variable BlockSize (S704). The variable j is then incremented (S705), and the process returns to step S702. If the variable BlockSize is equal to or smaller than the face size 504 of the face region [j] 502 (No at S703), the variable j is incremented (S705), and the process returns to step S702.

If the variable j is equal to or larger than the detected face count 501 (No at S702), the image data is divided into blocks whose size is BlockSize×BlockSize (S706). The variable i for counting is then initialized (S707), and whether the variable i is smaller than the detected face count 501 is determined (S708). If the variable i is equal to or larger than the detected face count 501 (No at S708), the calculation of brightness information by the brightness information calculation section 107 is terminated. If the variable i is smaller than the detected face count 501 (Yes at S708), brightness information of a block including the face center position 503 of the face region [i] 502 is calculated (S709). The variable i is then incremented (S710), and the process returns to step S708.

By executing the processing in steps S701 through S710 as described above, brightness information is calculated.

In the flow shown in FIG. 7, the detected face count 501 in step S702 may be replaced with the stored face count 508 stored in the information storage section 109, and also the face size 504 of the face region [j] 502 in steps S703 and S704 may be replaced with the face size 511 of the face information [j] 509, to permit the image data to be divided into blocks based on the detection result stored in the information storage section 109 for calculation of brightness information.

The brightness information calculated according to the flows shown in FIGS. 6 and 7 is used for calculation of the degree of importance by the importance degree calculation section 108 to be described later. In the flow of FIG. 7, in particular, in which the brightness information is calculated by dividing the image data into blocks based on the detection result output from the face detection section 106, calculation of the degree of importance using such brightness information can be effective. In the initialization of the variable BlockSize for block size setting in step S701, it is desirable to set the maximum value (INI_BLOCK) of the face size detected.

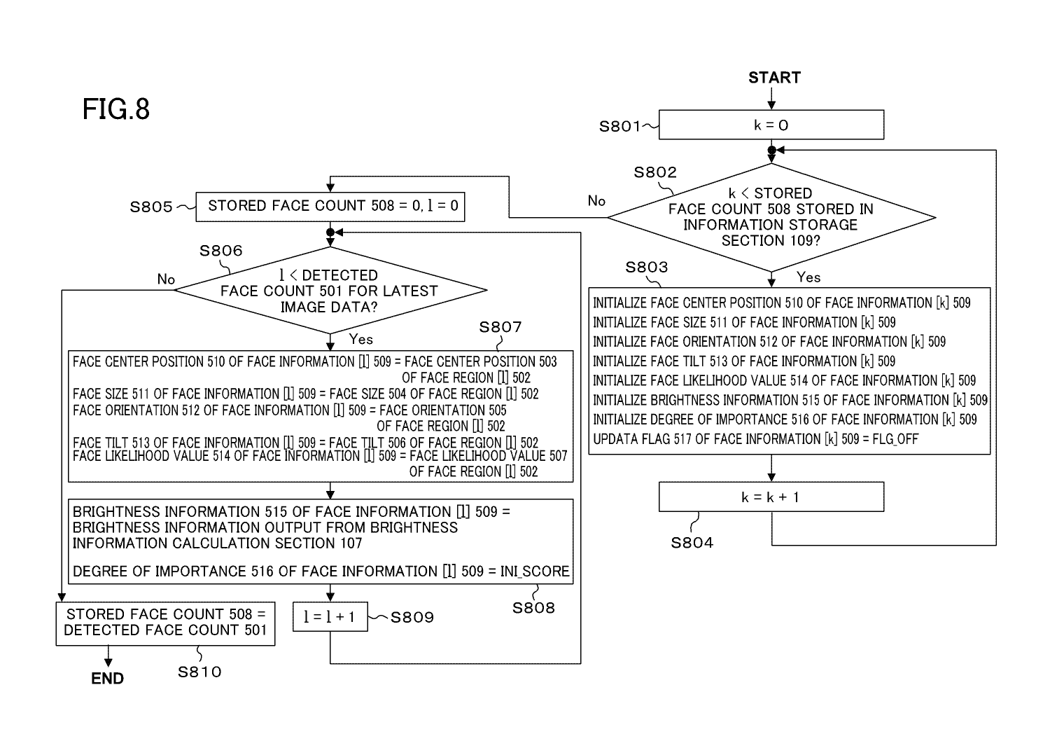

Next, details of the processing in step S405 (FIG. 4) will be described. FIG. 8 shows a flow of initialization of the information storage section 109.

A variable k for counting is initialized (S801), and whether the variable k is smaller than the stored face count 508 stored in the information storage section 109 is determined (S802).

If the variable k is smaller than the stored face count 508 (Yes at S802), the face center position 510, face size 511, face orientation 512, face tilt 513, face likelihood value 514, brightness information 515, degree of importance 516, and update flag 517 of the face information [k] 509 are initialized (S803). The variable k is then incremented (S804), and the process returns to step S802.

Note that in this embodiment, the update flag 517 is on (FLG_ON) when the degree of importance 516 has been updated, and off (FLG_OFF) when no update is done.

If the variable k is equal to or larger than the stored face count 508 (No at S802), the stored face count 508 and a variable l for counting are initialized (S805), and whether the variable l is smaller than the detected face count 501 for the latest image data is determined (S806).

If the variable l is equal to or larger than the detected face count 501 (No at S806), the detected face count 501 is assigned to the stored face count 508 (S810), and the initialization of the information storage section 109 is terminated.

If the variable l is smaller than the detected face count 501 (Yes at S806), the face center position 503, face size 504, face orientation 505, face tilt 506, and face likelihood value 507 of the face region [l] 502 are respectively assigned to the face center position 510, face size 511, face orientation 512, face tilt 513, and face likelihood value 514 of the face information [l] 509 (S807). Also, the brightness information output from the brightness information calculation section 107 is assigned to the brightness information 515 of the face information [l] 509, and an initial value INI_SCORE of the degree of importance is assigned to the degree of importance 516 of the face information [l] 509 (S808). The variable l is then incremented (S809), and the process returns to step S806.

By executing the processing in steps S801 through S810 as described above, the information storage section 109 is initialized.

The initialization of the information storage section 109 is expected to be performed at arbitrary timing, such as at power-on of the camera system and at mode change of the camera system.

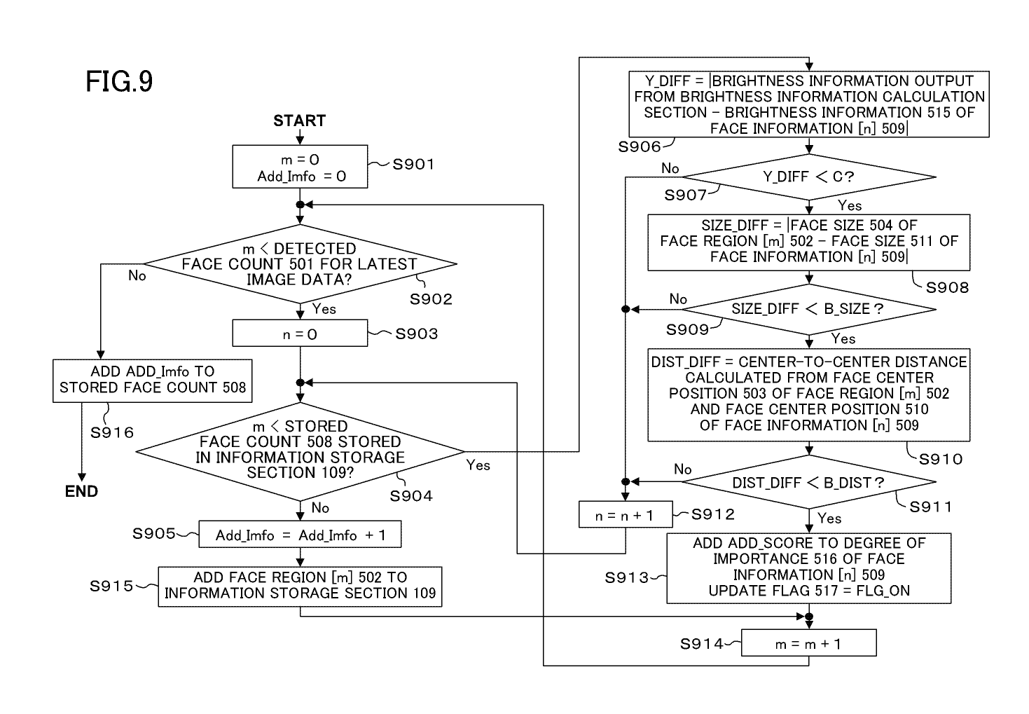

Next, details of the processing in step S406 (FIG. 4) will be described. FIG. 9 shows a flow of calculation of the degree of importance by the importance degree calculation section 108.

A variable m for counting and a variable Add_imfo for counting face information added to the information storage section 109 are initialized (S901), and whether the variable m is smaller than the detected face count 501 for the latest image data is determined (S902).

If the variable m is equal to or larger than the detected face count 501 (No at S902), the variable Add_imfo is added to the stored face count 508 stored in the information storage section 109 (S916), and the calculation of the degree of importance is terminated.

If the variable m is smaller than the detected face count 501 (Yes at S902), a variable n for counting is initialized (S903), and whether the variable n is smaller than the stored face count 508 is determined (S904).

If the variable n is smaller than the stored face count 508 (Yes at S904), the absolute value of the difference between the brightness information output from the brightness information calculation section 107 and the brightness information 515 of the face information [n] 509 is assigned to a variable Y_DIFF (S906), and whether the variable Y_DIFF is smaller than a threshold C (C is an arbitrary natural number) is determined (S907).

If the variable Y_DIFF is equal to or larger than the threshold C (No at S907), the variable n is incremented (S912) and the process returns to step S904.

If the variable Y_DIFF is smaller than the threshold C (Yes at S907), the absolute value of the difference between the face size 504 of the face region [m] 502 and the face size 511 of the face information [n] 509 is assigned to a variable SIZE_DIFF (S908), and whether the variable SIZE_DIFF is smaller than a threshold B_SIZE (B_SIZE is an arbitrary natural number) is determined (S909).

If the variable SIZE_DIFF is equal to or larger than the threshold B_SIZE (No at S909), the variable n is incremented (S912) and the process returns to step S904.

If the variable SIZE_DIFF is smaller than the threshold B_SIZE (Yes at S909), the center-to-center distance is calculated from the face center position 503 of the face region [m] 502 and the face center position 510 of the face information [n] 509, and the resultant distance is assigned to a variable DIST_DIFF (S910), and whether the variable DIST_DIFF is smaller than a threshold B_DIST (B_DIST is an arbitrary natural number) is determined (S911).

If the variable DIST_DIFF is equal to or larger than the threshold B_DIST (No at S911), the variable n is incremented (S912) and the process returns to step S904.

If the variable DIST_DIFF is smaller than the threshold B_DIST (Yes at S911), ADD_SCORE (arbitrary natural number) is added to the degree of importance 516 of the face information [n] 509, and FLG_ON is assigned to the update flag 517 of the face information [n] 509 (S913). The variable m is then incremented (S914), and the process returns to step S902.

If the variable n is equal to or larger than the stored face account 508 (No at S904), the variable Add_imfo is incremented (S905), and the face region [m] 502 is added to the information storage section 109 (S915). In step S915, the face center position 503, face size 504, face orientation 505, face tilt 506, and face likelihood value 507 of the face region [m] 502 are respectively assigned to the face center position 510, face size 511, face orientation 512, face tilt 513, and face likelihood value 514 of the face information [(stored face count−1)+Add_imfo] 509, the brightness information output from the brightness calculation section 107 is assigned to the brightness information 515 of the face information [n+Add_imfo] 509, and an initial value INI_SCORE (INI_SCORE is an arbitrary natural number) of the degree of importance 516 is assigned to the degree of importance 516 of the face information [n+Add_imfo] 509. Subsequent to step S915, the variable m is incremented (S914), and the process returns to step S902.

By executing the processing in steps S901 through S916 as described above, the degree of importance is calculated.

The comparison of the absolute value of the difference in brightness information with a threshold (S906 and S907), the comparison of the absolute value of the difference in face size with a threshold (S908 and S909), and the comparison of the face center-to-center distance with a threshold (S910 and S911) are performed in this order in FIG. 9, but the order of these comparisons is changeable. Also, although the degree of importance 516 is calculated by performing the comparison of the absolute value of the difference in brightness information with a threshold (S906 and S907), the comparison of the absolute value of the difference in face size with a threshold (S908 and S909), and the comparison of the face center-to-center distance with a threshold (S910 and S911) in FIG. 9, the degree of importance 516 may otherwise be calculated by adding comparison of the absolute value of the difference in face likelihood value (507 and 514) with a threshold, comparison of the absolute value of the difference in face orientation (505 and 512) with a threshold, and comparison of the absolute value of the difference in face tilt (506 and 513) with a threshold to the above comparisons.

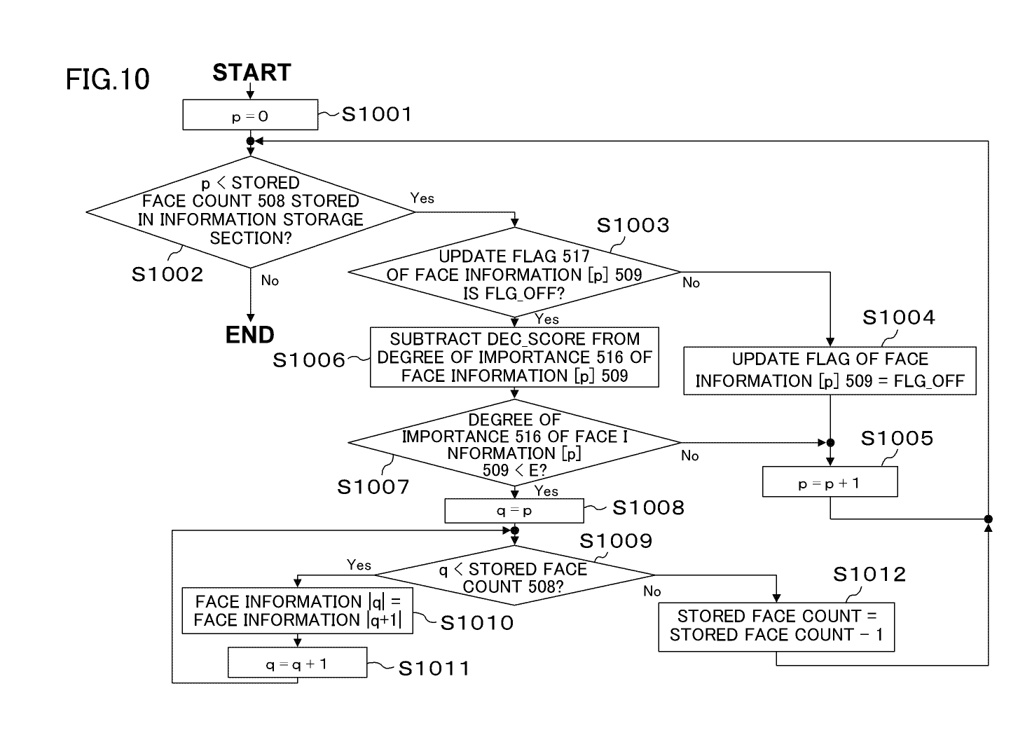

Next, details of the processing in step S407 (FIG. 4) will be described. FIG. 10 shows a flow of determination on whether to delete face information stored in the information storage section 109 by the information deletion determination section 111.

A variable p for counting is initialized (S1001), and whether the variable p is smaller than the stored face count 508 stored in the information storage section 109 is determined (S1002).

If the variable p is equal to or larger than the stored face count 508 (No at S1002), the determination of deletion of the face information is terminated.

If the variable p is smaller than the stored face count 508 (Yes at S1002), whether the update flag 517 of the face information [p] 509 is FLG_OFF is determined (S1003).

If the update flag 517 of the face information [p] 509 is FLG_ON (No at S1003), the update flag 517 of the face information [p] 509 is changed to FLG_OFF (S1004). The variable p is then incremented (S1005), and the process returns to step S1002.

If the update flag 517 of the face information [p] 509 is FLG_OFF (Yes at S1003), DEC_SCORE (an arbitrary natural number) is subtracted from the degree of importance 516 of the face information [p] 509 (S1006), and whether the resultant degree of importance 516 of the face information [p] 509 is smaller than a threshold E (E is an arbitrary natural number) is determined (S1007).

If the degree of importance 516 of the face information [p] 509 is equal to or larger than the threshold E (No at S1007), the variable p is incremented (S1005), and the process returns to step S1002.

If the degree of importance 516 of the face information [p] 509 is smaller than the threshold E, p is assigned to a variable q for counting (S1008), and whether the variable q is smaller than the stored face count 508 is determined (S1009).

If the variable q is smaller than the stored face count 508 (Yes at S1009), face information [q+1] 509 is assigned to face information [q] 509 (S1010). In step S1010, the face center position 510, face size 511, face orientation 512, face tilt 513, face likelihood value 514, brightness information 515, degree of importance 516, and update flag 517 of the face information [q+1] 509 are respectively assigned to the face center position 510, face size 511, face orientation 512, face tilt 513, face likelihood value 514, brightness information 515, degree of importance 516, and update flag 517 of the face information [q] 509. Subsequent to step S1010, the variable q is incremented (S1011), and the process returns to step S1009.

If the variable q is equal to or larger than the stored face count 508 (No at S1009), the stored face count 508 is decremented (S1012), and the process returns to step S1002.

By executing the processing in steps S1001 through S1012 as described above, whether to delete face information stored in the information storage section 109 is determined.

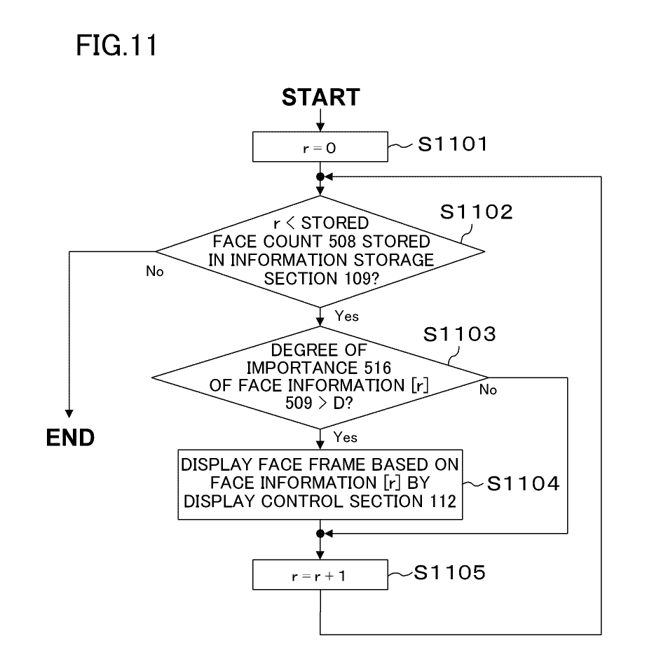

Next, details of the processing in steps S408 and S409 (FIG. 4) will be described. FIG. 11 shows a flow of determination on whether to display face information stored in the information storage section 109 by the display determination section 110 and display of a face frame by the display control section 112.

A variable r for counting is initialized (S1101), and whether the variable r is smaller than the stored face count 508 stored in the information storage section 109 is determined (S1102).

If the variable r is equal to or larger than the stored face count 508 (No at S1102), the determination of display and display of a face frame is terminated.

If the variable r is smaller than the stored face count 508 (Yes at S1102), whether the degree of importance 516 of the face information [r] 509 is larger than a threshold D (D is an arbitrary natural number) is determined (S1103).

If the degree of importance 516 of the face information [r] 509 is equal to or smaller than the threshold D (No at S1103), the variable r is incremented (S1105), and the process returns to step S1102.

If the degree of importance 516 of the face information [r] 509 is larger than the threshold D (Yes at S1103), a face frame is displayed based on the face information [r] 509 by the display control section 112 (S1104). The variable r is then incremented (S1105), and the process returns to step S1102.

By executing the processing in steps S1101 through S1105 as described above, whether to display face information is determined and a face frame is displayed.

### Second Embodiment

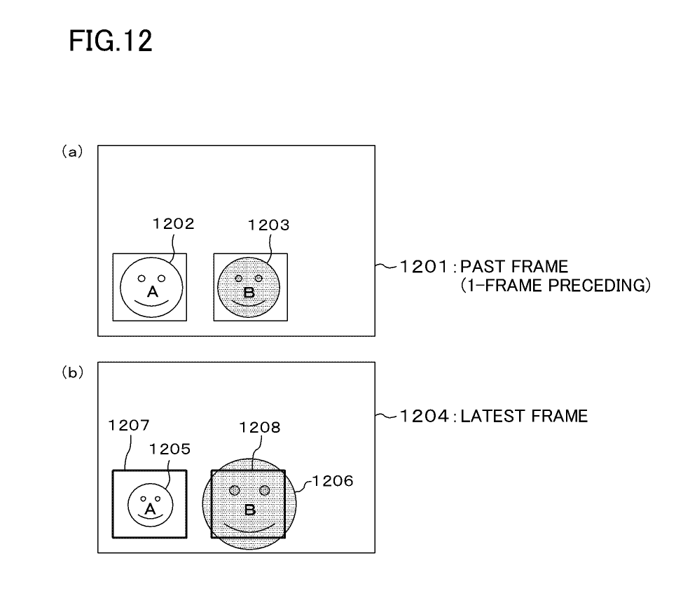

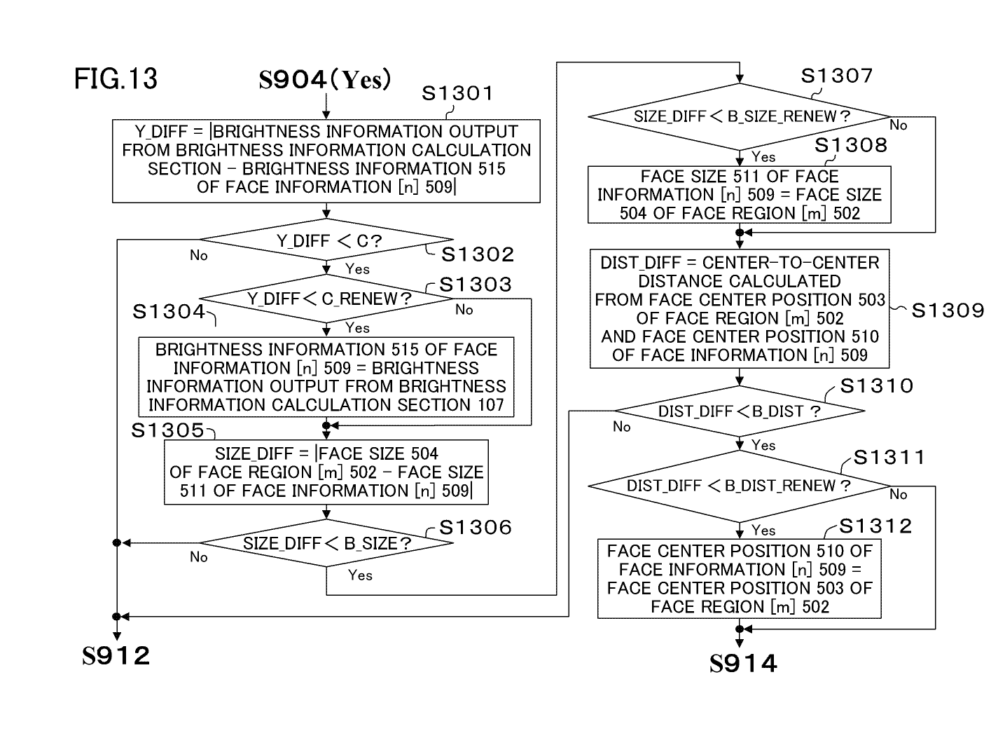

When a face frame is displayed according to the flow described in the first embodiment, the face center position 510, face size 511, and brightness information 515 of any face information 509 stored in the information storage section 109 are not updated. Assuming that image data in which a subject has moved forward is input sequentially as shown in FIGS. 12A and 12B, a discrepancy occurs between the actual face size and the size of the face frame as shown in FIG. 12B, making the image hard to see. To overcome this problem, the flow of calculation of the degree of importance shown in FIG. 9 may be modified, to update the face center position 510, the face size 511, and the brightness information 515. FIG. 13 shows a flow of update of the face center position 510, the face size 511, and the brightness information 515.

If the condition in step S904 in FIG. 9 is satisfied, the absolute value of the difference between the brightness information output from the brightness information calculation section 107 and the brightness information 515 of the face information [n] 509 is assigned to the variable Y_DIFF (S1301), and whether the variable Y_DIFF is smaller than the threshold C is determined (S1302).

If the variable Y_DIFF is equal to or larger than the threshold C (No at S1302), the process returns to step S912.

If the variable Y_DIFF is smaller than the threshold C (Yes at S1302), whether the variable Y_DIFF is smaller than a threshold C_RENEW (C_RENEW is an arbitrary natural number) is determined (S1303).

If the variable Y_DIFF is smaller than the threshold C_RENEW (Yes at S1303), the brightness information output from the brightness information calculation section 107 is assigned to the brightness information 515 of the face information [n] 509 (S1304).

If the variable Y_DIFF is equal to or larger than the threshold C_RENEW (No at S1303), or subsequent to step S1304, the absolute value of the difference between the face size 504 of the face region [m] 502 and the face size 511 of the face information [n] 509 is assigned to the variable SIZE_DIFF (S1305), and whether the variable SIZE_DIFF is smaller than the threshold B_SIZE is determined (S1306).

If the variable SIZE_DIFF is equal to or larger than the threshold B_SIZE (No at S1306), the process returns to step S912.

If the variable SIZE_DIFF is smaller than the threshold B_SIZE (Yes at S1306), whether the variable SIZE_DIFF is smaller than a threshold B_SIZE_RENEW (B_SIZE_RENEW is an arbitrary natural number) is determined (S1307).

If the variable SIZE_DIFF is smaller than the threshold B_SIZE_RENEW (Yes at S1307), the face size 504 of the face region [m] 502 is assigned to the face size 511 of the face information [n] 509 (S1308).

If the variable SIZE_DIFF is equal to or larger than the threshold B_SIZE_RENEW (No at S1307), or subsequent to step S1308, the center-to-center distance is calculated from the face center position 503 of the face region [m] 502 and the face center position 510 of the face information [n] 509, and the resultant distance is assigned to the variable DIST_DIFF (S1309), and whether the variable DIST_DIFF is smaller than the threshold B_DIST is determined (S1310).

If the variable DIST_DIFF is equal to or larger than the threshold B_DIST (No at S1310), the process returns to step S912.

If the variable DIST_DIFF is smaller than the threshold B_DIST (Yes at S1310), whether the variable DIST_DIFF is smaller than a threshold B_DIST_RENEW (B_DIST_RENEW is an arbitrary natural number) is determined (S1311).

If the variable DIST_DIFF is smaller than the threshold B_DIST_RENEW (Yes at S1311), the face center position 503 of the face region [m] 502 is assigned to the face center position 510 of the face information [n] 509 (S1312).

If the variable DIST_DIFF is equal to or larger than the threshold B_DIST_RENEW (No at S1311), or subsequent to step S1312, step S914 is executed.

By executing the processing in steps S1301 through S1312 as described above, whether to update the face information 509 is determined.

The comparison of the absolute value of the difference in brightness information with a threshold (S1301, S1302, S1303, and S1304), the comparison of the absolute value of the difference in face size with a threshold (S1305, S1306, S1307, and S1308), and the comparison of the face center-to-center distance with a threshold (S1309, S1310, S1311, and S1312) are performed in this order in FIG. 13, but the order of these comparisons is changeable.

Also, in FIG. 13, the brightness information 515, the face size 511, and the face center position 510 are updated by performing the comparison of the absolute value of the difference in brightness information with a threshold (S1301, S1302, S1303, and S1304), the comparison of the absolute value of the difference in face size with a threshold (S1305, S1306, S1307, and S1308), and the comparison of the face center-to-center distance with a threshold (S1309, S1310, S1311, and S1312). In addition, the face likelihood value 514, the face orientation 512, and the face tilt 513 can also be updated by adding comparison of the absolute value of the difference in face likelihood value (507 and 514) with a threshold, comparison of the absolute value of the difference in face orientation (505 and 512) with a threshold, and comparison of the absolute value of the difference in face tilt (506 and 513) with a threshold.

The size of data stored in the information storage section 109 will be described. In Patent Document 1, in which all the detected results for a plurality of units of image data are stored, when the number of face regions detected from each unit of image data increases, the size of data required to be stored becomes large. However, according to the embodiments of the present invention, the detection result for the latest image data is subjected to the comparison of the absolute value of the difference in brightness information with a threshold, the comparison of the absolute value of the difference in face size with a threshold, and the comparison of the face center-to-center distance with a threshold, to update the brightness information 515, the face size 511, the face center position 510, and the degree of importance 516 stored in the information storage section 109. Thus, the size of data stored is small.

As the embodiments of the present invention, the image processing device 113 and the imaging device 114 provided with the same were described. It should be noted that the present invention also includes, as another embodiment, a program that instructs a computer to work as the means corresponding to the face detection section 106, the brightness calculation section 107, the importance degree calculation section 108, the display determination section 110, the information deletion determination section 111, and the display control section 112 shown in FIG. 1 and execute the processing shown in FIG. 4.

It should also be noted that the way of displaying a face frame described in the first and second embodiments is merely an example and can be modified in various ways.

The present invention is not limited to the embodiments described above but can be embodied in other various forms without departing from the spirit or major features thereof. The foregoing embodiments are merely illustrative in every aspect and should not be construed restrictively. The scope of the present invention is to be defined by the appended claims rather than by the details of the foregoing description. All of modifications and changes falling within the scope of equivalence of the appended claims are also intended to be within the scope of the invention.

According to various embodiments of the present invention, a correct face frame can be displayed on a through image in an easy to see manner. Therefore, the present invention is applicable to digital cameras, monitor cameras, etc.

What is claimed is:

1. An image processing device, comprising:
a frame memory configured to store input image data;
a display determination section configured to determine whether to display a specific region in the image data based on brightness information of the image data; and
a display control section configured to display the specific region according to the determination by the display determination section.

2. An image processing device, comprising:
a frame memory configured to store input image data;
a specific region detection section configured to detect a specific region in the image data;
a brightness information calculation section configured to calculate brightness information of the image data;
an importance degree calculation section configured to calculate a degree of importance of a detection result output from the specific region detection section;
an information storage section configured to store specific region information including the detection result, the brightness information, and the degree of importance and the number of units of specific region information;
a display determination section configured to determine whether to display the specific region information; and
a display control section configured to display the specific region information according to the determination by the display determination section.

3. The image processing device of claim 2, further comprising:
an information deletion determination section configured to determine whether to delete the specific region information from the information storage section.

4. The image processing device of claim 2, wherein
the importance degree calculation section calculates the degree of importance based on a comparison result between the detection result stored in the information storage section and a detection result detected by the specific region detection section for latest input image data.

5. The image processing device of claim 2, wherein
the importance degree calculation section calculates the degree of importance based on a comparison result between the brightness information stored in the information storage section and brightness information calculated by the brightness information calculation section for latest input image data.

6. The image processing device of claim 2, wherein
the display determination section determines whether to display the specific region information based on the degree of importance.

7. The image processing device of claim 3, wherein
the information deletion determination section determines whether to delete the specific region information based on the degree of importance.

8. The image processing device of claim 2, wherein
the brightness information calculation section divides the image data into F×G (F and G are arbitrary integers) blocks and calculates brightness information of the blocks.

9. The image processing device of claim 2, wherein
the brightness information calculation section divides the image data into blocks based on the detection result stored in the information storage section or a detection result detected by the specific region detection section for latest input image data, and calculates brightness information of the blocks.

10. The image processing device of claim 8, wherein
the brightness information calculation section calculates brightness information of an arbitrary block based on a detection result detected by the specific region detection section for latest input image data.

11. The image processing device of claim 2, wherein
the specific region is a region of a face of a person.

12. An imaging device, comprising:
an imaging element configured to receive light of a subject incident via an optical lens, convert the light to an imaging signal, and output the imaging signal;
an analog signal processing section configured to convert the imaging signal output from the imaging element to a digital signal;
a digital signal processing section configured to perform predetermined signal processing for the digital signal output from the analog signal processing section; and
the image processing device of claim 2 configured to process image data output from the digital signal processing section as the input image data.

13. An image processing method, comprising the steps of:
(a) storing input image data;
(b) detecting a specific region in the image data;
(c) calculating brightness information of the image data;
(d) calculating a degree of importance of a detection result in the step (b);
(e) storing specific region information including the detection result in the step (b), the brightness information calculated in the step (c), and the degree of importance calculated in the step (d) and the number of units of specific region information;
(f) determining whether to display the specific region information based on the degree of importance;
(g) determining whether to delete the specific region information stored in the step (e) based on the degree of importance; and
(h) displaying the specific region information according to the determination in the step (f).

14. The image processing method of claim 13, wherein
the specific region is a region of a face of a person.

15. An image processing program configured to instruct a computer to execute the steps of:
(a) storing input image data;
(b) detecting a specific region in the image data;
(c) calculating brightness information of the image data;
(d) calculating a degree of importance of a detection result in the step (b);
(e) storing specific region information including the detection result in the step (b), the brightness information calculated in the step (c), and the degree of importance calculated in the step (d) and the number of units of specific region information;
(f) determining whether to display the specific region information based on the degree of importance;
(g) determining whether to delete the specific region information stored in the step (e) based on the degree of importance; and
(h) displaying the specific region information according to the determination in the step (f).

16. The image processing program of claim 15, wherein
the specific region is a region of a face of a person.
